(19) United States
(12) Patent Application Publication
(10) Pub. No.: US 2014/0111474 A1
(43) Pub. Date: Apr. 24, 2014

(54) MULTIPLEXED CONDUCTORS USING DYNAMICALLY CONFIGURABLE CONTROLLER IN CAPACITIVE TOUCH SENSORS

(71) Applicant: Cirque Corporation, Salt Lake City, UT (US)

(72) Inventor: Jared G. Bytheway, Sandy, UT (US)

(73) Assignee: Cirque Corporatidon, Salt Lake City, UT (US)

(21) Appl. No.: 14/057,701

(22) Filed: Oct. 18, 2013

Related U.S. Application Data
(60) Provisional application No. 61/715,424, filed on Oct. 18, 2012.

(51) Int. Cl. G06F 3/044

(52) U.S. Cl. CPC G06F 3/044
USPC 345/174

(57) ABSTRACT

A system and method for dynamically reconfiguring a touch sensor controller that transmits signals to and receives signals from an electrode array of a capacitance sensitive touch sensor, wherein multiplexing of signals to and from the controller enables reconfiguration of input and output pins to thereby increase the functions and versatility of a touch sensor controller.

### BACKGROUND OF THE INVENTION

1. Field of the Invention

This invention relates generally to capacitance sensitive touch sensors. Specifically, the invention relates to a dynamically configurable touch sensor controller that transmits signals to and receives signals from an electrode array, wherein multiplexing of signals to and from the controller enables reconfiguration of input and output pins.

2. Description of Related Art

There are several designs for capacitance sensitive touch sensors. It is useful to examine the underlying technology to better understand how any capacitance sensitive touchpad can be modified to work with the present invention.

The CIRQUE™ Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24. Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

Many capacitive touchpads for input devices operate as the CIRQUE® touchpad described above. Conductive electrodes are disposed on insulating substrates, and are used to measure the change in capacitance on the electrodes when a conductive or dielectric object is moved close enough to the electrodes to interfere with signals that are generated on drive electrodes and received by sense electrodes. Various methods are also known for stimulating the drive electrodes and measuring signals on the sense electrodes. Some of these methods include dedicated conductors for the drive and sense electrodes.

One example of prior art capacitance touchpads is taught in U.S. Pat. No. 5,305,017. In this patent, two layers of orthogonal but co-planar electrodes are used. One layer is first used as the drive electrodes while the other layer functions as the sense electrodes. The function of the layers are then switched, and the drive electrodes function as sense electrodes and the sense electrodes function as drive electrodes.

A touchpad controller is capable of sending specific stimulus patterns or signals to the drive electrodes, depending on the nature of the object being detected. Likewise, the manner in which the sense electrodes are used to detect and track the object can also be changed by the touchpad controller. The layout of the electrodes can also be arranged in patterns that are suitable for a wide range of stimulus patterns and sense configurations. However, the arrangement of electrodes may not be ideal for all types of measurements that can be made with a touchpad.

It would be an advantage over the prior art to provide a new touchpad controller that is dynamically configurable in order to provide optimized connections to an array of capacitive touchpad electrodes.

### BRIEF SUMMARY OF THE INVENTION

In a preferred embodiment, the present invention is a system and method for dynamically reconfiguring a touch sensor controller that transmits signals to and receives signals from an electrode array of a capacitance sensitive touch sensor, wherein multiplexing of signals to and from the controller enables reconfiguration of input and output pins on the touch sensor controller to thereby increase versatility of a touch sensor controller and the electrode array that it controls.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be modified to operate in accordance with the principles of the present invention.

FIG. 2 is a block diagram of a first embodiment of the present invention showing a touch sensor controller coupled to a single electrode array.

FIG. 3 is a block diagram of a second embodiment of the present invention showing a touch sensor controller coupled to a plurality of electrode arrays.

FIG. 4 is a schematic diagram showing an example of the first embodiment in more detail.

FIG. 5 is a block diagram of a touch sensor controller.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “proximity sensor”, “touch and proximity sensor”, “touch panel”, “touchpad” and “touch screen”, except when explicitly distinguished from the other terms.

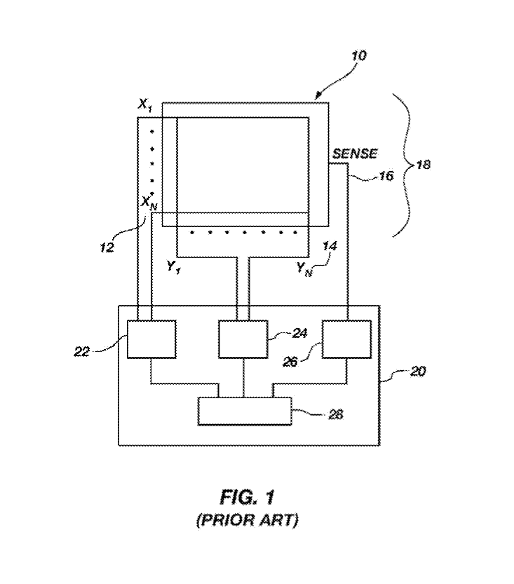

The prior art block diagram shown in FIG. 1 shows that the touch sensor controller 20 includes signal generators 22, 24 for generating drive signals. A separate generator is shown for each array of X (12) and Y (14) electrodes because each of the X and Y arrays can function as drive electrodes. The sense electrodes 16 are shown as being coupled to capacitance measurement circuit 26.

It should also be understood that the X and Y electrodes 12, 14 may also function as the drive and sense electrodes. Thus, when the X electrodes 12 function as the drive electrodes, the Y electrodes 14 may function as the sense electrodes, and vice versa.

An important feature to recognize is that the touch sensor controller 20 has input and output pins that are dedicated to the functions being performed. Thus, the output pins from the signal generators 22, 24 can only function as output pins. Furthermore, the output pins can only function as output pins that provide drive signals.

Similarly, the input pins to the capacitance measurement circuit 26 may only function as input pins. Furthermore, the input pins can only be coupled to the capacitance measurement circuit 26.

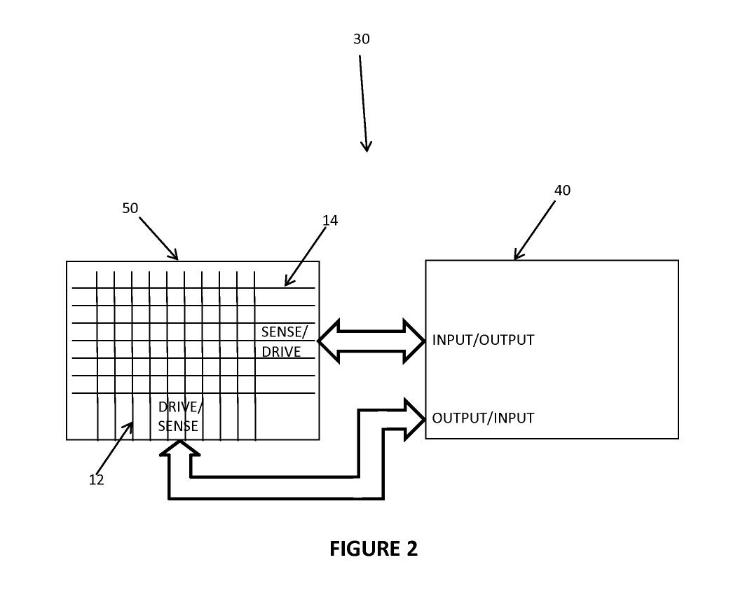

FIG. 2 is a first embodiment of the invention. FIG. 2 is a block diagram of a touch sensor controller 40 and an electrode array 50 that form a touch sensor 30. This embodiment is illustrating the concept that all of the pins on the touch sensor controller 40 may be dynamically configurable. In other words, each and every pin on the touch sensor controller 40 may function as an input or as an output. The touch sensor controller 40 may internally route pins assigned as output to a drive signal generator and route pins assigned as input to a capacitance measurement circuit. Furthermore, if the functions of the pins needs to be reversed such as when X and Y electrodes 12, 14 of the electrode array 50 switch functions of drive and sense, the touch sensor controller 40 may also make that change internally. In this embodiment, no external multiplexer or de-multiplexer is needed.

The touch sensor controller 40 may be capable of internally reconfiguring a pin assignment in order to make pin assignments dynamic instead of static. The implications of this first embodiment may be understood by a comparison to the prior art of FIG. 1. FIG. 1 shows at least two distinct differences. First, all output pins are only capable of transmitting signals from the touch sensor controller 20 because they are hardwired to components that only send output signals. Second, the output pins are only capable of transmitting drive signals because they are hardwired to the signal generators 22, 24. Thus, not only are the output pins only functioning as output pins, they can only send one type of output signal.

In contrast, the first embodiment of the present invention not only enables each pin to be reconfigured as an input or an output pin, but the input signal may be routed to any component within touch sensor controller 40. Likewise, each output pin may be coupled to any component within the touch sensor controller 40.

The dynamic reconfiguration of the function of each input and output pin is controllable by the touch sensor controller 40. The touch sensor controller 40 may include a processor that may dynamically control routing of signals throughout the touch sensor controller using circuits that are well known to those skilled in the art. For example, multiplexers and de-multiplexers can be used to control the routing of signals.

One aspect of the first embodiment is that the aspect ratio of the electrode array 50 that can be controlled by the touch sensor controller 40 is now modifiable. In other words, a touch sensor 30 having a 16×16 electrode array of X and Y electrodes in an electrode grid 50 requires 16 output pins and 16 input pins from the touch sensor controller 40 in order to send and receive all the signals necessary for operation. Accordingly, the touch sensor controller 40 that could function with the electrode array could not function on an electrode array that required 20 input pins and 12 output pins. While both electrode arrays require a total of 32 pins to a touch sensor controller 40, the specific number of input and output pins varies. Thus, a 20×12 electrode array would require a different touch sensor controller 40.

In accordance with the principles of the first embodiment, the touch sensor controller 40 may be reconfigured to be coupled to the 20×12 electrode array and still function as desired. The same total number of pins are being controlled, and the touch sensor controller 40 may assign any pin to be an input or an output as needed.

It should also be understood that it is another aspect of the first embodiment that an electrode array having fewer electrodes is also controllable by the touch sensor controller 40. Thus, the touch sensor controller 40 may be capable of configuring a much larger number of pins than are actually needed by the electrode array 50.

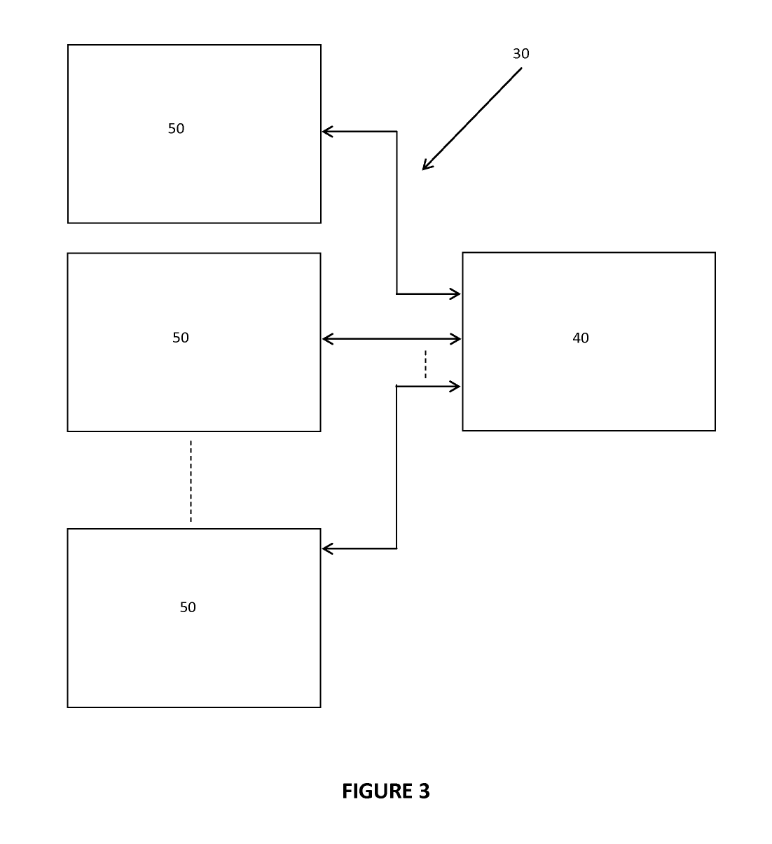

FIG. 3 is a block diagram of a second embodiment of the present invention. In this embodiment, the touch sensor controller 40 may be coupled to a plurality of electrode arrays 50 to form a touch sensor 30 having a plurality of separate electrode arrays 50. The touch sensor controller 40 may be capable of separately and simultaneously controlling a plurality of electrode arrays 50. To enable control of a plurality of electrode arrays 50, the touch sensor controller 40 needs to have a unique pin that may be assigned to each electrode of each of the plurality of electrode arrays 50.

The plurality of electrode arrays 50 may be arranged separate from each other or they may be adjacent to each other to form a single larger touch sensor 30.

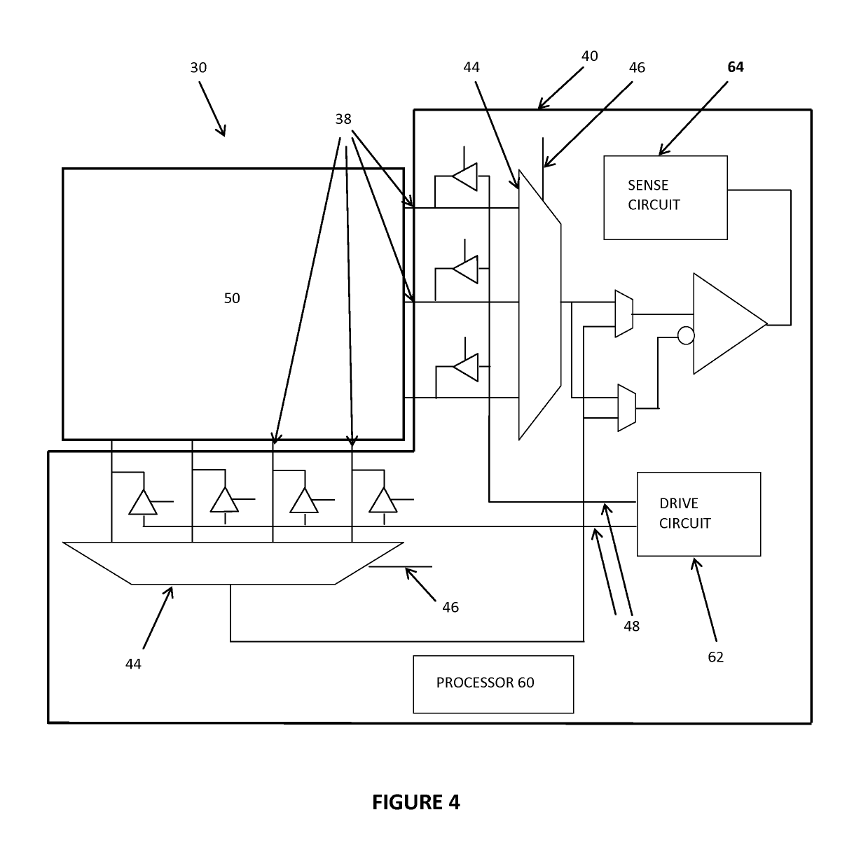

FIG. 4 is a schematic diagram showing some additional detail of the block diagram of FIG. 2. FIG. 4 is an example only, and should not be considered as limiting of the concepts and embodiments of the touch sensor 30. What is shown is one possible configuration for how the input pins and output pins of the touch sensor controller 40 may be dynamically configured. Specifically, multiplexers 44 may be used to receive sense signals from the electrode array 50. The multiplexers may be controlled using control signals 46 to select which signals pass through to be analyzed by a capacitance measurement circuit. Drive signals may also be selectively transmitted using electrode signals line 48.

The number of X and Y electrodes in the electrode array 50 should also not be considered to be a limiting factor of the embodiment. Any number of X and Y electrodes may be used in the electrode array 50. All that is important is that the touch sensor controller 40 have enough pins to be able to make a connection to the desired number of electrodes.

For the embodiment of FIG. 4, it should be understood that any pattern of signals may be applied to the electrode array 50 and any desired system for sensing return signals may be used, and should also not be considered a limiting factor of the embodiment.

One advantage of applying a pattern, making a measurement, shifting the pattern and then repeating these steps, is that the effective resolution of the touch sensor may be increased. Instead of the resolution being dependent on the size of the pattern being applied, this method can use a large pattern but shift the entire pattern along the drive electrodes, resulting in higher resolution.

Another aspect of this embodiment is that various patterns may be applied to the electrode array 50 depending on the type of measurement being made. For example, one drive pattern may be applied for the purpose of determining if a finger is present anywhere on the touch sensor. A different drive pattern may then be applied for determining a coarse finger location, such as in a particular region of the touch sensor. Finally, a different drive pattern may then be applied to determine a more precise location of the finger within a specific region. A different drive pattern may also be applied that can be used in an electrically noisy environment. All of these different drive patterns may be applied using the present invention.

While the embodiments above are directed to the finding and tracking of a single object, it should also be understood that the touch sensor may also be used to transmit certain drive patterns in order to determine the location of more than one object on the electrode array 50 of the touch sensor. In other words, the touch sensor may be capable of multi-finger detection and tracking.

Another aspect of the embodiment is that the drive electrodes or the sense electrodes may be single ended or differential.

Control of the operation of the touch sensor controller 40 may be implemented from within the touch sensor controller itself or it may be done externally. If implemented from within, the touch sensor controller 40 may include a processor 60. What is important is that the touch sensor controller 40 include some control means for controlling the use of the plurality of input/output pins 38. In other words, there must be some control means, such as the processor 60, for coupling a pin to the sense circuitry 64 or to the drive circuitry 62, and then for transmitting a drive signal or receiving and analyzing a sense signal.

It should be understood that the number of input/output pins 38 may be varied. Thus, not all of the input/output pins 38 may be used when connecting to the electrode array 50. Furthermore, the number of input/output pins 38 that are used as X electrodes may be a different number than what are used for the Y electrodes, or they may be the same number.

In a third embodiment of the present invention, the dynamic reconfiguration of input and output pins on the touch sensor controller 40 is not limited to only transmitting drive signals from output pins and receiving sense signals from input pins. In this third embodiment, it is another aspect of the invention that output signals other than drive signals and input signals other than sense signals may also be dynamically controlled by the touch sensor controller 40.

The functionality of touch sensors 30 is increasing for many reasons. One reason is the ability to combine more functions with a touch sensor 30. For example, consider a smart phone. Smart phones may include near field communication (NFC) functionality in future devices, enabling a person to conduct monetary transactions with their mobile phone. NFC functionality is not the only function that may be combined with a touch sensor 30, but is an example only, and should not be considered as limiting. The present invention includes any functions that might be combined with a touch sensor.

For example, it may be desirable to generate a buffered sensing signal or some other active signal on an output pin. The sensing signal or active signal may be broadcast to a shielding plane or shielding electrodes in order to protect the touch sensor 30 from interference by other signal sources or parasitic capacitances. Such shielding may increase the sensitivity of the touch sensor 30. Another option may be to configure a pin to couple to ground to thereby couple a grounding plane or electrode to ground. Another function that may be provided by the touch sensor controller 40 is to provide input and/or output pins for use with a tethered stylus.

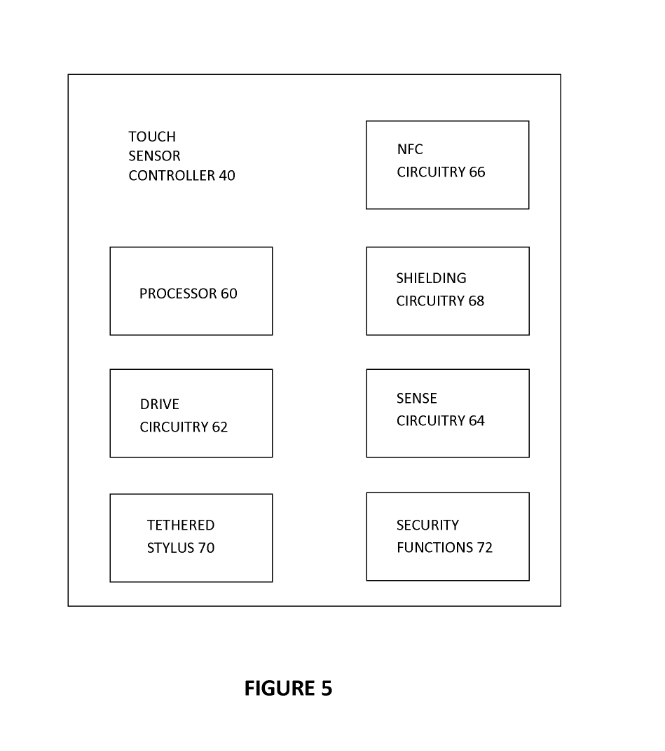

Accordingly, FIG. 5 is provided to illustrate in a block diagram that a touch sensor controller 40 may include a processor 60, drive circuitry 62 for generating drive signals that are transmitted on output pins, sense circuitry 64 for analyzing signals received from the sense inputs received on input pins, NFC circuitry 66 for generating and receiving signals from an NFC antenna, shielding circuitry 68 for generating signals that may be used to protect any electronic circuits from interference, and circuitry that may be used to operate a tethered stylus 70. The touch sensor controller 40 may also include any other functions such as security functions 72 that require the use of input or output pins from the touch sensor controller 40.

Regarding the electrode array 50 of the touch sensor 30, it is another aspect of the embodiments of the present invention that the touch sensor controller 40 may be coupled to a single layer electrode array 50 for single-layer touch sensor applications. A multi-layer electrode array 50 is not required.

Regarding further functionality of the touch sensor controller 40, it may be an advantage to be able to swap functionality of drive electrodes and sense electrodes as disclosed in co-pending application Ser. No. 13/193,457. The ability to perform axis swapping by swapping drive and sense electrode functionality may reduce the effects of noise coupling on the electrodes of the electrode array 50.

Regarding improvement of touch sensor 30 operation, another aspect of the embodiments may be to have one or more input or output pins coupled to discrete capacitors. For example, coupling discrete capacitors to sense electrodes in the electrode array 50 enables injection of a signal into the sense electrodes for the purpose of balancing out the electrode array, injecting offset, and performing security or obfuscation functions.

A security application of the touch sensor controller 40 may come as a result of the ability to internally short or tie together various electrodes. Typically, tying electrodes together would require a plurality of external buses routed to all the electrode pins where any electrode pin could connect to a bus. However, the present invention enables a grouping function of drive or sense electrodes, where the grouping is all performed internally in the touch sensor controller 40.

Apart from security purposes, input and output pins on the touch sensor controller 40 may serve functions other than as connections to an electrode array 50. For example, the input and output pins may function as general purpose input/output signaling pins (GPIO). General purpose input/output signaling pins may be used as button inputs from the touch sensor. Another function may be to drive signals to LEDs as part of a display or signaling output. These should be considered as examples only and limiting of the possible applications of the GPIO.

Another function of the touch sensor controller 40 may be to provide repurposing of electrodes in the electrode array 50. For example, the electrodes may function as electrodes of the touch sensor 30 or as electrodes for an NFC antenna. In other words, the electrodes may be multiplexed such that during a first time period the electrode array is functioning as a touch sensor. During a second time period, the same electrodes may be used as an NFC antenna by changing routing of pins and connections between the pins within the touch sensor controller 40.

For example, a dedicated loop antenna used for NFC purposes may also be multiplexed to function as a touch or proximity sensor for sensing far distances which may be easier to do with a larger conductor like an NFC antenna. By changing configurations using the dynamically controllable input and output pins of the touch sensor controller 40, these or other functions may all be implemented.

In an alternative embodiment, the touch sensor controller 50 may not be coupled to an electrode array but may instead be coupled at least one conductive object. It may be a single large object or a plurality of objects, and that may or may not be constructed as an array of parallel electrodes but may have any other desired shape that is needed to perform a different function. Thus, the plurality of input\output pins of the touch sensor controller may be coupled to a differently shaped object or objects and then perform a primary or secondary function of a driven shield, a proximity sensor, an antenna, a ground shield and a touch sensor, or other desired function that may be implemented using the hardware of the present invention.

It is to be understood that the arrangements described above are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A dynamically configurable touch sensor controller, said touch sensor controller comprising:
a plurality of pins that function as either input or output pins;
a drive circuit for generating drive signals;
a sense circuit for measuring sense signals, wherein each of the plurality of pins may be coupled to the drive circuit and to the sense circuit, such that each of the plurality of pins may function as a drive pin for transmitting a drive signal or as a sense pin for receiving a sense signal;
a control means for dynamically coupling each of the plurality of pins to the drive circuit or to the sense circuit, wherein the control means may change the connection of any of the plurality of pins so that any of the plurality of pins may function as a drive pin or as a sense pin.

2. The touch sensor controller as defined in claim 1 wherein the drive circuit is further comprised of a drive signal generator for generating at least one drive signal to be transmitted on at least one of the plurality of pins that is functioning as a drive electrode.

3. The touch sensor controller as defined in claim 1 wherein the sense circuit is further comprised of a capacitance measurement circuit for measuring a capacitance on at the least one of the plurality of pins that is functioning as a sense electrode.

4. The touch sensor controller as defined in claim 1 wherein a system is provided that includes the touch sensor controller and further comprises an electrode array having a plurality of X and Y electrodes that may function as either sense or drive electrodes, wherein the plurality of X and Y electrodes are coupled to the plurality of pins of the touch sensor controller having a one-to-one correspondence.

5. The system as defined in claim 4 wherein the system is further comprised of a plurality of electrode arrays.

6. The electrode array as defined in claim 4 wherein the electrode is further comprised of a multi-layer electrode array.

7. The electrode array as defined in claim 4 wherein the electrode is further comprised of a single layer electrode array.

8. The touch sensor controller as defined in claim 1 wherein the touch sensor controller is capable of single object and multi-object detection and tracking.

9. The touch sensor controller as defined in claim 1 wherein the control means includes at least one multiplexer for controlling connections between the plurality of pins and the sense circuit.

10. The touch sensor controller as defined in claim 1 wherein the control means includes at least one control signal for controlling connections between the plurality of pins and the sense circuit and between the plurality of pins and the drive circuit.

11. The touch sensor controller as defined in claim 1 wherein the touch sensor controller further comprises a secondary function, the secondary function being selected from the group of secondary functions comprised of near field communication circuitry, shielding circuitry, tethered stylus circuitry, security circuitry and grounding circuitry.

12. A method for dynamically configuring a touch sensor controller, said method comprising:
providing a plurality of pins that function as either input or output pins, providing a drive circuit for generating drive signals and a sense circuit for measuring sense signals, wherein each of the plurality of pins may be coupled to the drive circuit and to the sense circuit, such that each of the plurality of pins may function as a drive pin for transmitting a drive signal or as a sense pin for receiving a sense signal; and
dynamically coupling each of the plurality of pins to the drive circuit or to the sense circuit using a control means, wherein the control means may change the connection of any of the plurality of pins so that any of the plurality of pins may function as a drive pin or as a sense pin.

13. The method as defined in claim 12 wherein the method further comprises dynamically changing a function of the plurality of pins between functioning as an output and an input pin, to thereby enable the plurality of pins to dynamically switch between functioning as a connection to a drive electrode and a sense electrode.

14. The method as defined in claim 12 wherein the method further comprises providing a drive signal generator for generating at least one drive signal to be transmitted on at least one of the plurality of pins that is functioning as a drive electrode.

15. The method as defined in claim 12 wherein the method further comprises providing a capacitance measurement circuit for measuring a capacitance on at the least one of the plurality of pins that is functioning as a sense electrode.

16. The method as defined in claim 12 wherein the method further comprises providing a system that includes the touch sensor controller and further comprises an electrode array having a plurality of X and Y electrodes that may function as either sense or drive electrodes, wherein the plurality of X and Y electrodes are coupled to the plurality of pins of the touch sensor controller having a one-to-one correspondence.

17. The method as defined in claim 12 wherein the method further comprises providing a plurality of electrode arrays.

18. The method as defined in claim 12 wherein the method further comprises providing a multi-layer electrode array.

19. The method as defined in claim 12 wherein the method further comprises providing a single layer electrode array.

20. The method as defined in claim 12 wherein the method further comprises providing single object and multi-object detection and tracking.

21. The method as defined in claim 12 wherein the method further comprises providing a secondary function, the secondary function being selected from the group of secondary functions comprised of near field communication circuitry, shielding circuitry, tethered stylus circuitry, security circuitry and grounding circuitry.

22. The method as defined in claim 21 wherein the method further comprises coupling at least one conductive object to the plurality of pins of the touch sensor controller to thereby provide a function that is selected from the group of functions comprised of a driven shield, a proximity sensor, an antenna, a ground shield and a touch sensor.
